(19) United States
(12) Patent Application Publication
(10) Pub. No.: US 2009/0189574 A1
(43) Pub. Date: Jul. 30, 2009

(54) SIMPLIFIED MAXIMUM POWER POINT CONTROL UTILIZING THE PV ARRAY VOLTAGE AT THE MAXIMUM POWER POINT

(75) Inventors: THANH LE, FERNDALE, WA (US); SIMON TSZ SUI YAN, VANCOUVER (CA); WEN SHI, BELLINGHAM, WA (US)

Correspondence Address: SCHACHT LAW OFFICE, INC., SUITE 202, 2801 MERIDIAN STREET, BELLINGHAM, WA, 98225-2412, US

(73) Assignee: ALPHA TECHNOLOGIES, INC., BELLINGHAM, WA (US)

(21) Appl. No.: 12/358,496

(22) Filed: Jan. 23, 2009

Related U.S. Application Data
(60) Provisional application No. 61/062,187, filed on Jan. 23, 2008.

(51) Int. Cl. G05F 1/10

(52) U.S. Cl. 323/234

(57) ABSTRACT

A converter system adapted to be connected between a photovoltaic power source and a load comprises a converter circuit, a control circuit, and a PWM generator circuit. The converter circuit is operatively connected to transfer energy from the photovoltaic power source to the load. The control circuit generates a raw control signal based on at least a voltage generated by the photovoltaic power source. The PWM generator circuit is operatively connected to the converter circuit and generates a PWM switch signal based on the raw control signal. The converter circuit transfers energy from the photovoltaic power source to the load based on the PWM switch signal.

### RELATED APPLICATIONS

This application (Attorneys' Ref. No. P216086) claims benefit of U.S. Provisional Patent Application Ser. No. 61/062,187 filed Jan. 23, 2008. The subject matter of the foregoing related application is incorporated herein by reference.

### TECHNICAL FIELD

The present invention relates the generation of power using photovoltaics (PV) and, more specifically, to systems and methods for maximizing the power output from PV arrays.

### BACKGROUND

PV arrays have a general current source behavior with a maximum power point that varies with insolation levels and cell temperature. It is desirable to maximize the power output from photovoltaic (PV) arrays under varying operating conditions such as insolation, cell temperature, and cable length. Although a PV array may be used to charge a variety of different loads, the present invention is of particular significance in the context of a system for charging a battery, and the present invention will be discussed herein in the context of a PV array used to charge a battery.

The need thus exists for a signal conversion system that can maximize the power obtained from a PV array and which can be used with a variety of different loads.

### SUMMARY

The present invention may be embodied as a DC-DC converter system implementing a Maximum Power Point Tracking (MPPT) algorithm that adjusts the PV array's V-I operating point to maximize the power output of the array at a specific operating condition. Using a DC-DC converter system having a MPPT control algorithm, this form of the present invention can be used to maximize the power output from photovoltaic (PV) arrays.

The present invention may also be embodied as a DC-DC converter system or method that may be used in conjunction with a PV array. The PV array generates PV output power; the PV output power varies with factors such as insolation levels, temperature of the PV panels forming the PV array, and the lengths of cables carrying the PV output power. A DC-DC converter system implementing the principles of the present invention uses pulse-width modulation (PWM) to generate converter output power based on the PV output power generated by the PV array.

Another example of a DC-DC converter system of the present invention optimizes generation of the converter output power based on the PV output power under operating conditions such as insolation, cell temperature, and cable length. In an example method implementing the principles of the present invention, the PWM output power signal generated by a PV array is applied to a converter operating based on a PWM signal. The pulse width of the PWM signal is adjusted based on a voltage level of the PV output power to maintain the specified panel voltage at the predetermined maximum power point level. This method of control allows the use of very inexpensive, highly available standard voltage control PWM integrated circuit (IC).

The converter output power may be used to supply power to a variety of loads. As examples, the converter output power may be used directly as a power source for a device that operates on DC power, indirectly through an inverter as a source of AC power, or to charge an energy storage system such as a battery. The present invention will be described in detail below in the context of a system for charging a battery but may be applied to other loads.

In a charging application, the output of the DC-DC converter system is normally connected to a battery. The battery voltage changes as the State of Charge (SOC) changes. An energy storage device such as a battery operates under a fairly wide range of voltages; for example, a 48 volt battery system may operate acceptably from 44 volts to 60 volts. However, the PV output power of a PV system may and frequently does drop to below 44 volts. The principles of the present invention are most relevant when used to transfer power from a PV system and a load such as a battery system.

In the context of charging an energy storage system, the systems and methods of the present inventions also allow the specified panel voltage to be maintained under all conditions of battery SOC. When used in a charging application, a DC-DC converter system of the present invention may also be configured to satisfy secondary design goals such as battery overcharge protection and adapting a battery charging profile to maximize the lifetime of the battery.

The converter output power of a DC-DC converter system of the present invention thus may be regulated based on the PV output power from the PV panel source and not the converter output power. The present invention thus extracts maximum power from the PV panel regardless of factors such as solar energy level, panel temperature, and cable length. In addition, a DC-DC converter system of the present invention employs direct feed forward control based on the input voltage to the converter (PV output power voltage), yielding fast response to maintain the PV output power at the predetermined maximum power point level. Further, by ignoring the effects of the load, the systems and methods of the present invention eliminates complications that arise from reacting to load transients and attempting to sense the load voltage/current in a noisy environment.

The PV output power voltage will further vary based on the panel operating temperature, interconnecting impedance of power cable, and connector characteristics. Regulation of this voltage can be implemented using a relatively inexpensive microprocessor and/or a small analog control circuit at a relatively low speed loop and using heavy average current sensing to analyze the direction of change of the PV ouput power voltage level to achieve the maximum power.

Further, the systems and methods of the present invention can be configured to employ energy storage components that tend to damp load transients. Variations caused by ambient temperature, voltage drop across the power cable at different load levels, and/or changes in the solar energy level are very slow and can be heavily filtered to prevent the false responses due to noisy environment.

When configured to use input feed forward control of the panel voltage, the present invention can simplify the control of the PV output power signal of the PV system to achieve maximum power or minimum power with fastest response, inexpensive and simple control, and high level of immunity to noisy environment.

The present invention may thus be embodied as a converter system adapted to be connected between a photovoltaic power source and a load, comprising a converter circuit, a control circuit, and a PWM generator circuit. The converter circuit is operatively connected to transfer energy from the photovoltaic power source to the load. The control circuit generates a raw control signal based on at least a voltage generated by the photovoltaic power source. The PWM generator circuit is operatively connected to the converter circuit and generates a PWM switch signal based on the raw control signal. The converter circuit transfers energy from the photovoltaic power source to the load based on the PWM switch signal.

The present invention may also be configured as a method of connecting a photovoltaic power source to a load comprising the following steps. A converter circuit is arranged to transfer energy from the photovoltaic power source to the load. A raw control signal is generated based on at least a voltage generated by the photovoltaic power source. A PWM switch signal is generated based on the raw control signal. The converter circuit is operated based on the PWM switch signal to transfer energy from the photovoltaic power source to the load.

The present invention may also be embodied as converter system adapted to be connected between a photovoltaic power source and a load comprising a converter circuit, a control circuit, an error amplifier, a reference generator circuit, and a PWM generator circuit. The converter circuit is operatively connected to transfer energy from the photovoltaic power source to the load. The control circuit generates a raw control signal based on at least a voltage generated by the photovoltaic power source. The reference generator circuit is operatively connected to the error amplifier and generates a reference voltage signal. The PWM generator circuit is operatively connected to the converter circuit and generates a PWM switch signal based on the raw control signal. The converter circuit transfers energy from the photovoltaic power source to the load based on the PWM switch signal. The error amplifier generates a PWM control signal based on the raw control signal generated by the control circuit and the reference voltage signal generated by the reference generator. The PWM generator circuit generates the PWM switch signal based on the PWM control signal.

### DESCRIPTION OF THE DRAWINGS

FIG. 1 is a block diagram of a first embodiment of a DC-DC converter for converting the PV output power of a PV system into a DC power output for a load;

FIG. 2 is a block diagram of a second embodiment of a DC-DC converter for converting the PV output power of a PV system into a DC power output for a load;

FIG. 3 is a block diagram of a third embodiment of a DC-DC converter for converting the PV output power of a PV system into a DC power output for a load;

FIG. 4 is a block diagram of a fourth embodiment of a DC-DC converter for converting the PV output power of a PV system into a DC power output for a load; and

FIGS. 5A-5G contain a circuit diagram illustrating one example of the fourth embodiment of a DC-DC converter as depicted in FIG. 4.

### DETAILED DESCRIPTION

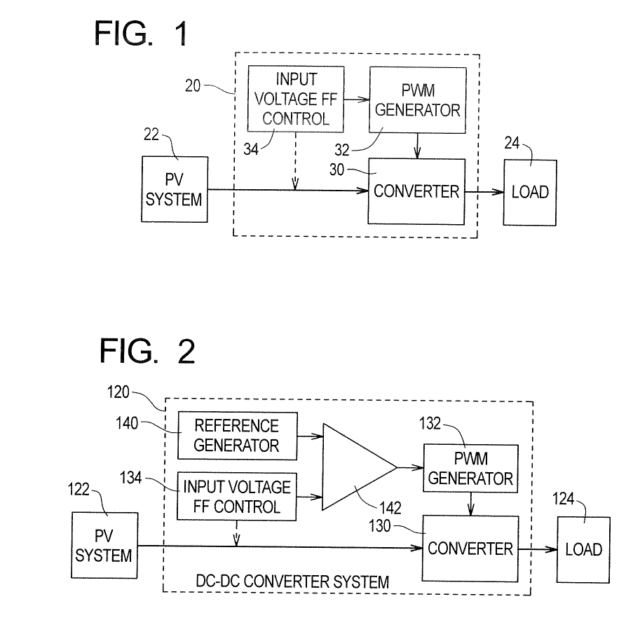

Referring now to FIG. 1 of the drawing, depicted therein is a first example of a DC-DC converter system 20 constructed in accordance with, and embodying, the principles of the present invention. The converter system 20 is arranged to convert PV output power from a PV system 22 into a signal appropriate for a load 24.

The converter system 20 comprises a converter circuit 30, a PWM generator circuit 32, and an input voltage feed forward control circuit 34. The converter circuit 30 can be configured to comprise a switching circuit (not shown in FIG. 1) comprising a power switch, an inductor, and a diode to transfer energy from the input (PV output power) to the output (converter output power). The components of the converter circuit 30 can be configured to form a step-down (buck), a step-up (boost), or an inverter (flyback) converter. The power switch is opened and closed based on a PWM signal generated as will be described in further detail below.

The input voltage feed forward control circuit 34 generates a PWM control signal based on the PV output power. In particular, the control circuit 34 generates the PWM control signal based on at least the voltage level of the PV output power. The PWM control signal generated by the control circuit 34 is input to the PWM generator circuit 32. The PWM generator circuit 32 generates a PWM switch signal that opens and closes the power switch of the converter circuit 30.

In the example converter system 20, the control circuit 34 generates the PWM control signal such that the PWM generator circuit 32 generates the PWM switch signal to: (a) generate the converter output power at a voltage appropriate for the load 24 and (b) optimize power transfer from the PV system 22 to the load 24. The example converter system 20 does not directly regulate the voltage level of the converter output power.

Referring now to FIG. 2 of the drawing, depicted therein is a second example of a DC-DC converter system 120 constructed in accordance with, and embodying, the principles of the present invention. The converter system 120 is arranged to convert PV output power from a PV system 122 into a signal appropriate for a load 124.

The converter system 120 comprises a converter circuit 130, a PWM generator circuit 132, and an input voltage feed forward control circuit 134. The example converter system 120 further comprises a reference generator circuit 140 and an error amplifier 142.

As with the example converter circuit 30 described above, the converter circuit 130 comprises components that can be configured to form a step-down (buck), a step-up (boost), or an inverter (flyback) converter. In each of these converter configurations, a power switch is opened and closed based on a PWM signal generated as will be described in further detail below.

The input voltage feed forward control circuit 134 generates a raw control signal based on at least the voltage level of the PV output power. The reference generator 140 generates a reference voltage level that can be preset or can be adjusted based on operating characteristics of the PV system 122 and/or the load 124. The error amplifier 142 generates a PWM control signal based on a comparison of the voltage level of the PV output power and the reference voltage level.

The PWM control signal generated by the error amplifier 142 is input to the PWM generator circuit 132. The PWM generator circuit 132 generates a PWM switch signal that opens and closes the power switch of the converter circuit 130.

In the example converter system 120, the control circuit generates the PWM control signal such that the PWM generator circuit 132 generates the PWM switch signal to: (a) generate the converter output power at a voltage appropriate for the load 124 and (b) optimize power transfer from the PV system 122 to the load 124. The example converter system 120 does not directly regulate the voltage level of the converter output power. However, the converter system 120 can be configured to compensate for certain variables associated with the PV system 122 and/or the load 124.

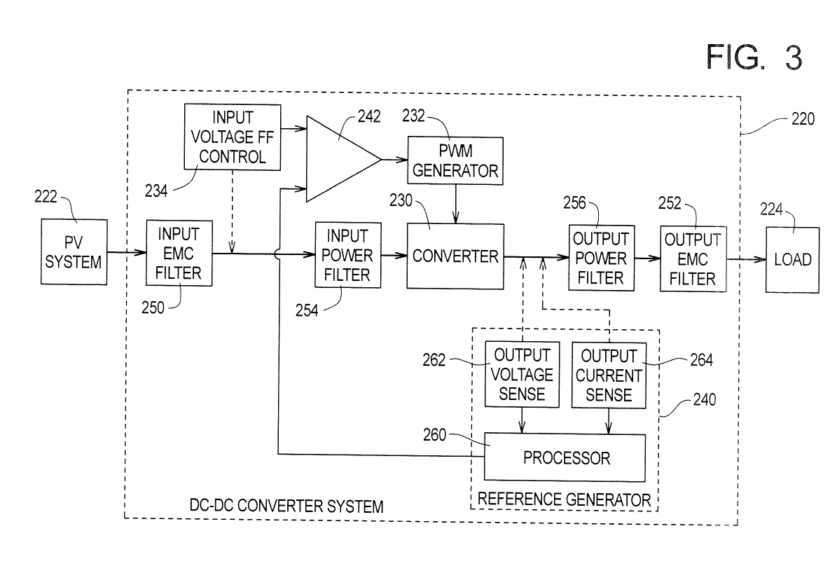

Referring now to FIG. 3 of the drawing, depicted therein is a third example of a DC-DC converter system 220 constructed in accordance with, and embodying, the principles of the present invention. The converter system 220 is arranged to convert PV output power from a PV system 222 into a signal appropriate for a load 224.

The converter system 220 comprises a converter circuit 230, a PWM generator circuit 232, and an input voltage feed forward control circuit 234. As with the example converter circuits 30 and 130 described above, the converter circuit 230 comprises components that can be configured to form a step-down (buck), a step-up (boost), or an inverter (flyback) converter. The power switch is opened and closed based on a PWM signal generated as will be described in further detail below.

The example converter system 220 further comprises a reference generator circuit 240 and an error amplifier 242. In addition, the example converter system 220 comprises an input EMC filter 250, and output EMC filter 252, an input power filter 254, and an output power filter 256.

The input EMC filter 250 and the input power filter 254 are arranged in series between the PV system 222 and the converter 230. The output power filter 256 and the output EMC filter 252 are arranged in series between the converter 230 and the load 224. The construction, operation, and purpose of the filters 250-256 are or may be conventional, and these filters 250-256 will not be described in detail herein.

The example reference generator circuit 240 comprises a processor 260, output voltage sense circuit 262, and output current sense circuit 264. The output voltage sense circuit 262 and output current sense circuit 264 are or may be conventional and generate output voltage and output current signals, respectively, associated with the converter output power. The processor 240 generates a reference voltage level based on the product of output voltage and output current signals. The reference voltage level is thus representative of the converter output power.

The input voltage feed forward control circuit 234 generates a raw control signal based on at least the voltage level of the PV output power. The reference generator 240 generates the reference voltage level based on operating characteristics of the PV system 222 and/or the load 224 as represented by the converter output power. The error amplifier 242 generates a PWM control signal based on a comparison of the voltage level of the PV output power and the reference voltage level.

The PWM control signal generated by the error amplifier 242 is input to the PWM generator circuit 232. The PWM generator circuit 232 generates a PWM switch signal that opens and closes the power switch of the converter circuit 230.

In the example converter system 220, the control circuit generates the PWM control signal such that the PWM generator circuit 232 generates the PWM switch signal to: (a) generate the converter output power at a voltage appropriate for the load 224 and (b) optimize power transfer from the PV system 222 to the load 224. The example converter system 220 does not directly regulate the voltage level of the converter output power. However, operation of the reference generator circuit 240 allows the converter system 220 to compensate for fluctuations in power associated with the PV system 222 and/or the load 224.

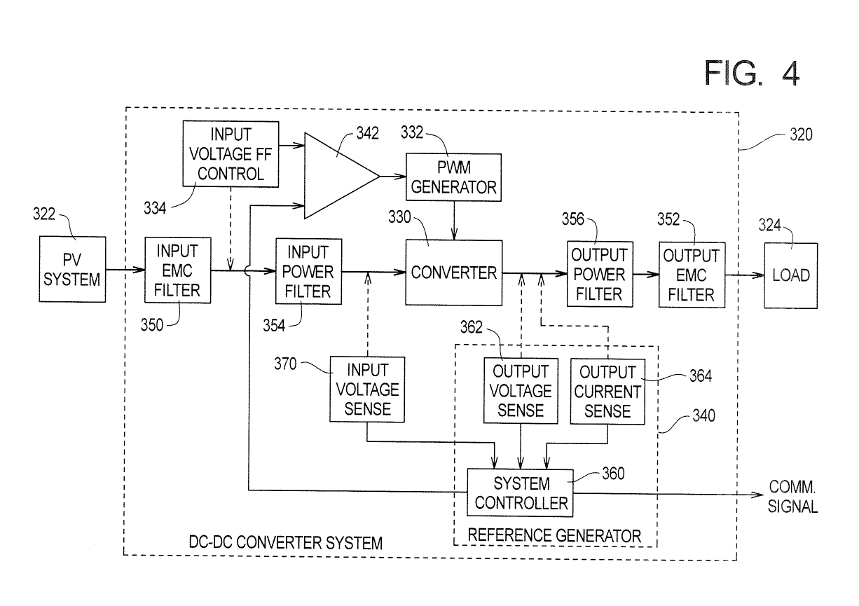

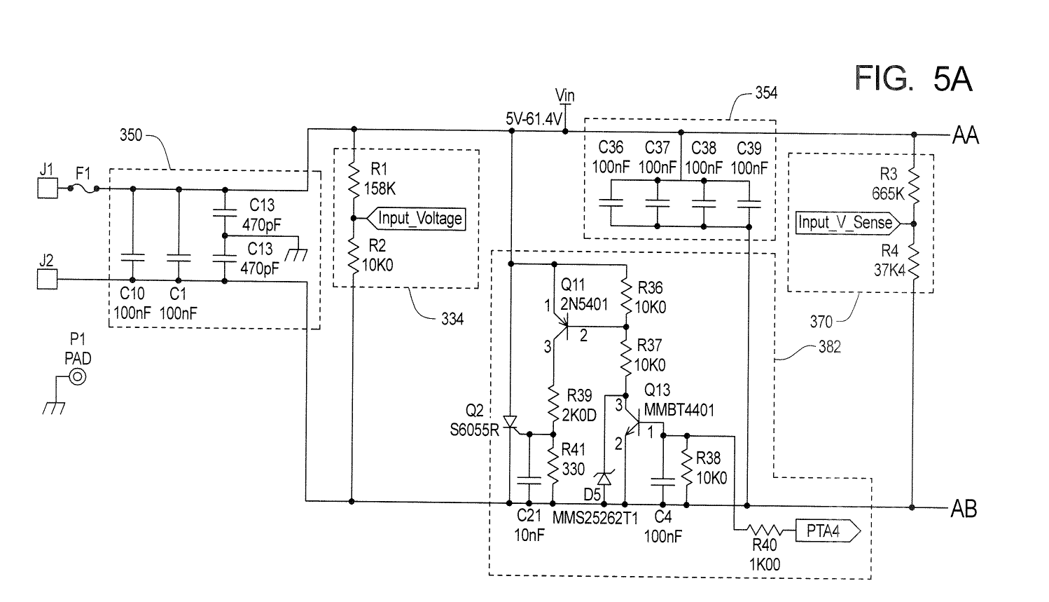

Referring now to FIG. 4 of the drawing, depicted therein is a fourth example of a DC-DC converter system 320 constructed in accordance with, and embodying, the principles of the present invention. The converter system 320 is arranged to convert PV output power from a PV system 322 into a signal appropriate for a load 324.

The converter system 320 comprises a converter circuit 330, a PWM generator circuit 332, and an input voltage feed forward control circuit 334. As with the example converter circuits 30, 130, and 230 described above, the converter circuit 330 comprises components that can be configured to form a step-down (buck), a step-up (boost), or an inverter (flyback) converter. The power switch is opened and closed based on a PWM signal generated as will be described in further detail below.

The example converter system 320 further comprises a reference generator circuit 340 and an error amplifier 342. In addition, the example converter system 320 comprises an input EMC filter 350, and output EMC filter 352, an input power filter 354, and an output power filter 356.

The input EMC filter 350 and the input power filter 354 are arranged in series between the PV system 322 and the converter 330. The output power filter 356 and the output EMC filter 352 are arranged in series between the converter 330 and the load 324. The construction, operation, and purpose of the filters 350-356 are or may be conventional, and these filters 350-356 will not be described in detail herein.

The example reference generator circuit 340 comprises a processor 360, output voltage sense circuit 362, and output current sense circuit 364. The example converter system 320 further comprises an input voltage sense circuit 370 that generates an input voltage signal representative of a voltage level of the PV output power.

The output voltage sense circuit 362 and output current sense circuit 364 are or may be conventional and generate output voltage and output current signals, respectively, associated with the converter output power. The processor 360 generates a reference voltage level based on the product of output voltage and output current signals. The reference voltage level is thus representative of the converter output power.

The input voltage feed forward control circuit 334 generates a raw control signal based at least the voltage level of the PV output power. The reference generator 340 generates the reference voltage level based on operating characteristics of the PV system 332 and/or the load 334 as represented by the converter output power. The error amplifier 342 generates a PWM control signal based on a comparison of the voltage level of the PV output power and the reference voltage level.

The PWM control signal generated by the error amplifier 342 is input to the PWM generator circuit 332. The PWM generator circuit 332 generates a PWM switch signal that opens and closes the power switch of the converter circuit 330.

In the example converter system 320, the control circuit generates the PWM control signal such that the PWM generator circuit 332 generates the PWM switch signal to: (a) generate the converter output power at a voltage appropriate for the load 324 and (b) optimize power transfer from the PV system 322 to the load 324. The example converter system 320 does not directly regulate the voltage level of the converter output power. However, operation of the reference generator circuit 340 allows the converter system 320 to compensate for fluctuations in power associated with the PV system 322 and/or the load 324.

The system controller 360 further can be configured to provide the converter system 320 to communicate with external status monitoring and/or data collection systems. The signals generated by the output voltage sense circuit 362, output current sense circuit 364, and/or input voltage sense circuit 370 may be represented as data that may be transmitted using a communications signal to any such monitoring and/or data collection system.

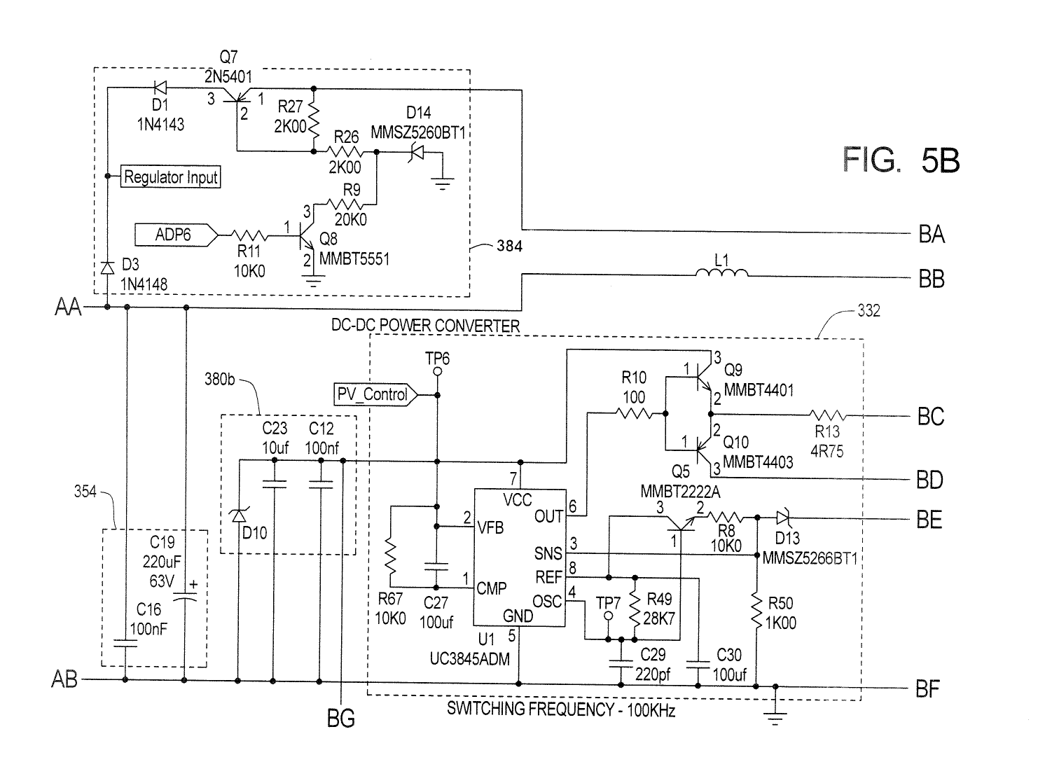

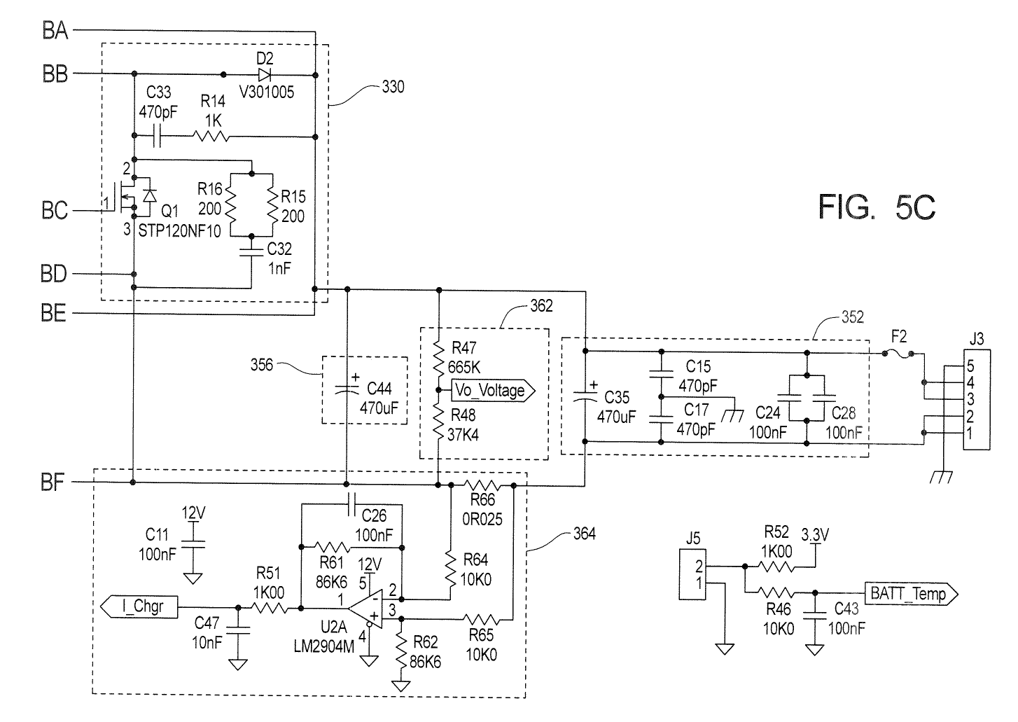

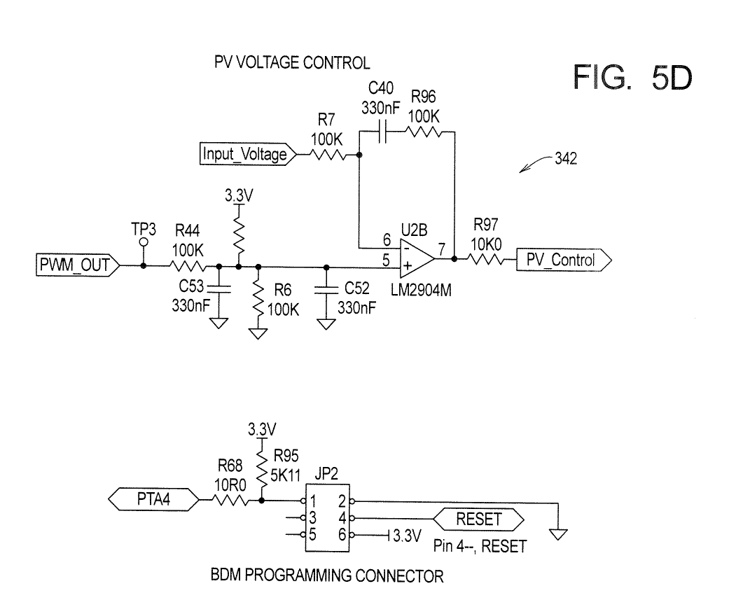

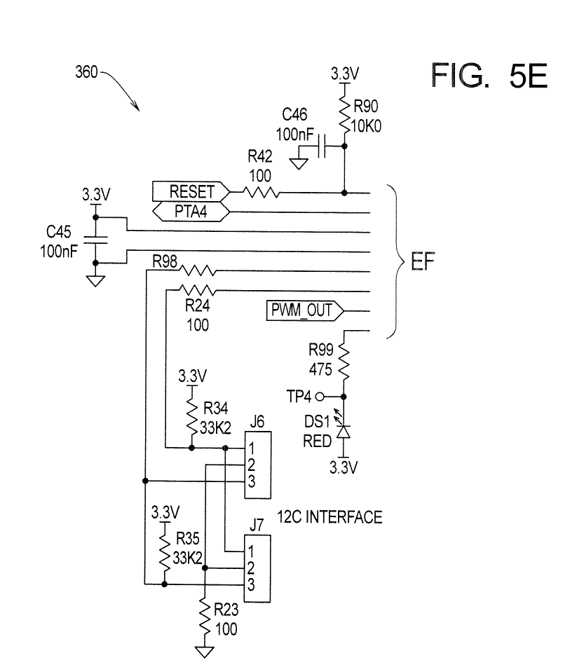

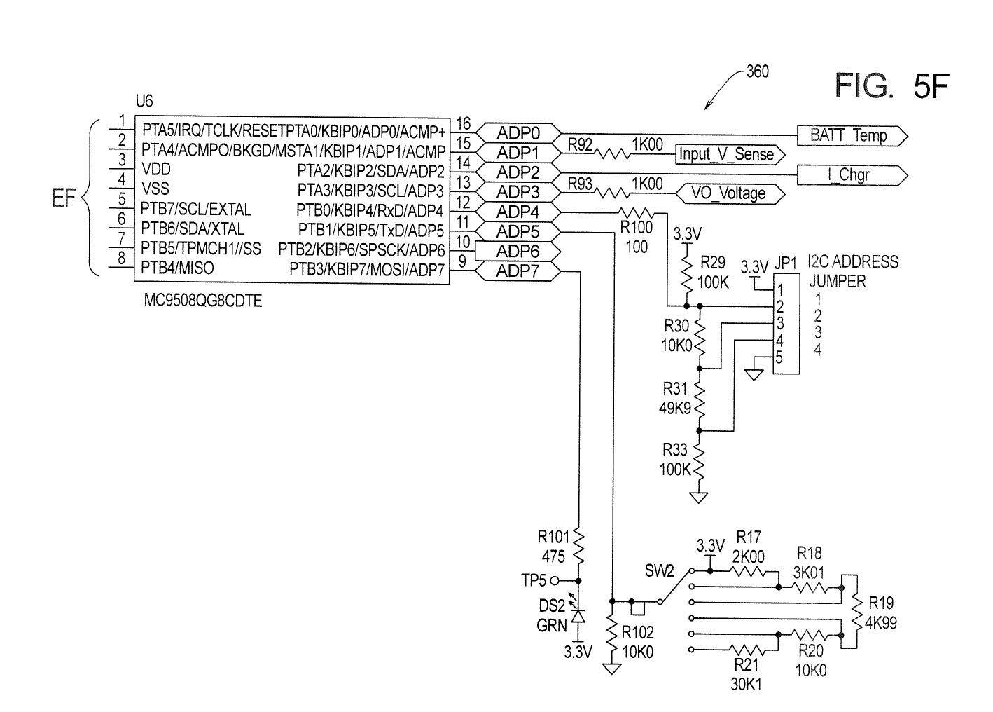

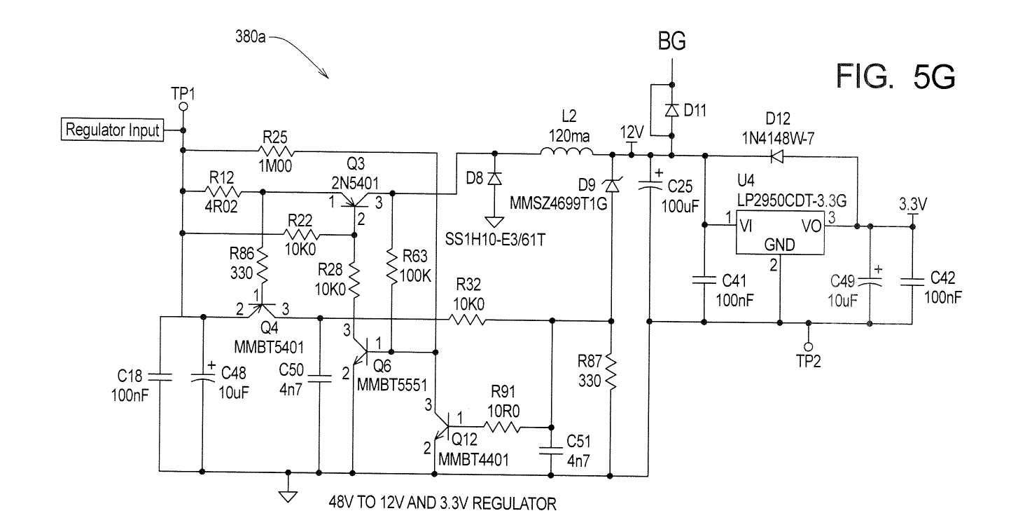

Turning now to FIGS. 5A-5G, depicted therein is an example of a circuit that may be used to implement the fourth example converter system 320 depicted and described with reference to FIG. 4. In particular, the circuit depicted in FIGS. 5A-5G comprises the converter circuit 330 (FIG. 5C), the PWM generator circuit 332 (FIG. 5B), the input voltage feed forward control circuit 334 (FIG. 5A), the error amplifier circuit 342 (FIG. 5D), the input EMC filter 350 (FIG. 5A), the output EMC filter 352 (FIG. 5C), the input power filter 354 (FIG. 5A), the output power filter 356 (FIG. 5C), the system controller 360 (FIGS. 5E and 5F), the output voltage sense circuit 362 (FIG. 5C), the output current sense circuit 364 (FIG. 5C), and the input voltage sense circuit 370 (FIG. 5A). In addition, FIGS. 5A-5G illustrate a power supply 380 (FIGS. 5B and 5G), an input protection circuit 382 (FIG. 5A), a low voltage disconnect circuit 384 (FIG. 5B), and other associated circuits, connectors and interfaces that may be used to construct an example embodiment of the fourth example converter circuit 320 of the present invention.

Given the foregoing, it should be apparent that the principles of the present invention may be embodied in forms other than those described above. The scope of the present invention should thus be determined the claims appended hereto and not the foregoing detailed description of the invention.

What is claimed is:

1. A converter system adapted to be connected between a photovoltaic power source and a load, comprising:
a converter circuit operatively connected to transfer energy from the photovoltaic power source to the load;
a control circuit that generates a raw control signal based on at least a voltage generated by the photovoltaic power source; and
a PWM generator circuit operatively connected to the converter circuit, where the PWM generator circuit generates a PWM switch signal based on the raw control signal; whereby
the converter circuit transfers energy from the photovoltaic power source to the load based on the PWM switch signal.

2. A converter system as recited in claim 1, in which:
the control circuit is operatively connected to the PWM generator circuit;
the raw control signal is a PWM control signal; and
the PWM generator circuit generates the PWM switch signal based on the PWM control signal.

3. A converter system as recited in claim 1, further comprising:
an error amplifier; and
a reference generator circuit operatively connected to the error amplifier, where the reference generator generates a reference voltage signal; whereby
the error amplifier generates a PWM control signal based on the raw control signal generated by the control circuit and the reference voltage signal generated by the reference generator; and
the PWM generator circuit generates the PWM switch signal based on the PWM control signal.

4. A converter system as recited in claim 3, in which the reference generator circuit comprises:
an output voltage sense circuit that generates an output voltage signal based on an output of the converter circuit; and
a processor operatively connected to the output voltage sense circuit, where the processor generates the reference voltage signal based on the output voltage signal.

5. A converter system as recited in claim 3, in which the reference generator circuit comprises:
an output current sense circuit that generates an output current signal based on an output of the converter circuit; and
a processor operatively connected to the output voltage sense circuit, where the processor generates the reference voltage signal based on the output current signal.

6. A converter system as recited in claim 3, in which the reference generator circuit comprises:
an output voltage sense circuit that generates an output voltage signal based on an output of the converter circuit;
an output current sense circuit that generates an output current signal based on the output of the converter circuit; and
a processor operatively connected to the output voltage sense circuit, where the processor generates the reference voltage signal based on at least one of the output voltage signal and the output current signal.

7. A converter system as recited in claim 3, in which the reference generator circuit comprises:
an input voltage sense circuit that generates an input voltage signal based on an output of the photovoltaic power source; and
a processor operatively connected to the output voltage sense circuit, where the processor generates the reference voltage signal based on the input voltage signal.

8. A converter system as recited in claim 3, in which the reference generator circuit comprises:
an input voltage sense circuit that generates an input voltage signal based on an output of the photovoltaic power source;
an output voltage sense circuit that generates an output voltage signal based on an output of the converter circuit;
an output current sense circuit that generates an output current signal based on the output of the converter circuit; and
a processor operatively connected to the output voltage sense circuit, where the processor generates the reference voltage signal based on at least one of the input voltage signal, the output voltage signal, and the output current signal.

9. A converter system as recited in claim 1, further comprising:
an input EMC filter and an input power filter operatively connected between the photovoltaic power source and the converter circuit; and
an output EMC filter and an output power filter operatively connected between the converter circuit and the load.

10. A converter system as recited in claim 1, further comprising a system controller for generating a communications signal based on at least one of an input to or an output of the converter circuit.

11. A converter system as recited in claim 8, in which the processor further generates a communications signal based on at least one the input voltage signal, the output voltage signal, and the output current signal.

12. A method of connecting a photovoltaic power source to a load, comprising:
arranging a converter circuit to transfer energy from the photovoltaic power source to the load;
generating a raw control signal based on at least a voltage generated by the photovoltaic power source; and
generating a PWM switch signal based on the raw control signal;
operating the converter circuit based on the PWM switch signal to transfer energy from the photovoltaic power source to the load.

13. A method as recited in claim 12, further comprising the steps of:
generating the raw control signal as a PWM control signal; and
generating the PWM switch signal based on the PWM control signal.

14. A method as recited in claim 12, further comprising the steps of:
generating a PWM control signal based on the raw control signal and a reference voltage signal; and
generating the PWM switch signal based on the PWM control signal.

15. A method as recited in claim 14, further comprising the steps of generating the reference voltage signal based on at least one of an input to the converter circuit and an output of the converter circuit.

16. A method as recited in claim 12, further comprising the step of generating a communications signal based on at least one of an input to the converter circuit or an output of the converter circuit.

17. A converter system adapted to be connected between a photovoltaic power source and a load, comprising:
a converter circuit operatively connected to transfer energy from the photovoltaic power source to the load;
a control circuit that generates a raw control signal based on at least a voltage generated by the photovoltaic power source;
an error amplifier;
a reference generator circuit operatively connected to the error amplifier, where the reference generator generates a reference voltage signal; and
a PWM generator circuit operatively connected to the converter circuit, where the PWM generator circuit generates a PWM switch signal based on the raw control signal; whereby
the converter circuit transfers energy from the photovoltaic power source to the load based on the PWM switch signal;
the error amplifier generates a PWM control signal based on the raw control signal generated by the control circuit and the reference voltage signal generated by the reference generator; and
the PWM generator circuit generates the PWM switch signal based on the PWM control signal.

18. A converter system as recited in claim 17, in which the reference generator circuit comprises:
an input voltage sense circuit that generates an input voltage signal based on an output of the photovoltaic power source;
an output voltage sense circuit that generates an output voltage signal based on an output of the converter circuit;
an output current sense circuit that generates an output current signal based on the output of the converter circuit; and
a processor operatively connected to the output voltage sense circuit, where the processor generates the reference voltage signal based on at least one of the input voltage signal, the output voltage signal, and the output current signal.

19. A converter system as recited in claim 1, further comprising:
an input EMC filter and an input power filter operatively connected between the photovoltaic power source and the converter circuit; and
an output EMC filter and an output power filter operatively connected between the converter circuit and the load.

20. A converter system as recited in claim 18, in which the processor further generates a communications signal based on at least one the input voltage signal, the output voltage signal, and the output current signal.
